(19) United States
(12) Patent Application Publication
(10) Pub. No.: US 2026/0367483 A1
(43) Pub. Date: Nov. 19, 2026

(54) LINEAR DRIVE DEVICE THAT IS LOW IN GUIDE RESISTANCE, LENS BARREL, AND IMAGE CAPTURING SYSTEM

(71) Applicant: CANON KABUSHIKI KAISHA, Tokyo (JP)

(72) Inventor: TAKUTO ICHIHARA, Tokyo (JP)

(21) Appl. No.: 19/663,745

(22) Filed: Apr. 30, 2026

(30) Foreign Application Priority Data
May 13, 2025 (JP) 2025-080413

(51) Int. Cl. G03B 13/34; G03B 5/02

(52) U.S. Cl. CPC G03B 13/34; G03B 5/02; G03B 2205/0046

(57) ABSTRACT

A linear drive device includes a linear guide that supports the driven body in a state movable in a first direction, and a linear actuator that drives a driven body in the first direction. The linear guide has a hollow cylindrical shaft having an internal space extending in the first direction. The linear actuator has a field part having permanent magnets and yokes, and a coil part having coils. The field part is arranged in the internal space of the shaft, and the coil part is arranged coaxially with the shaft with a fixed spacing between inner peripheral surfaces of the coils and an outer peripheral surface of the shaft. A sliding surface of a main engagement portion, slidably engaged with the shaft, has a comb-tooth shape which is intermittently brought into contact with the outer peripheral surface of the shaft in a circumferential direction.

### BACKGROUND

### Field of the Technology

The present disclosure relates to a linear drive device that is low in guide resistance, a lens barrel equipped with the linear drive device, and an image capturing system.

### Description of the Related Art

A linear drive device has been widely put to practical use for a positioning mechanism of a precision apparatus, a conveying apparatus, a transportation apparatus, and so forth. As the linear drive device, there has been conventionally proposed one using an electromagnetic linear DC motor or a friction-type linear ultrasonic motor, and further, there is known one that converts a rotational drive force generated by driving a rotary motor to a linear driving force by using a linear motion-converting mechanism, such as a rack and pinion mechanism.

For example, Japanese Laid-Open Patent Publication (Kokai) No. 2023-129928 and Japanese Laid-Open Patent Publication (Kokai) No. 2007-129824 each disclose a linear drive device that moves a lens forward and backward in an optical axis direction inside a lens barrel. Specifically, Japanese Laid-Open Patent Publication (Kokai) No. 2023-129928 discloses a configuration in which a plurality of linear actuators are arranged along an outer periphery of the lens in a case where the center of gravity of a driven body is within the lens. Further, Japanese Laid-Open Patent Publication (Kokai) No. 2007-129824 discloses a configuration in which a single linear actuator is arranged coaxially with a guide bar and at the same time connected to an engagement portion, which is engaged with the guide bar, of a lens holder.

According to the technique disclosed in Japanese Laid-Open Patent Publication (Kokai) No. 2023-129928, it is possible to make an action axis of thrust as the resultant force of the plurality of linear actuators close to the center of gravity of the driven body. Further, according to the technique disclosed in Japanese Laid-Open Patent Publication (Kokai) No. 2007-129824, it is possible to cause an action axis of thrust of the linear actuator to substantially coincide with the guide bar. As a result, according to the techniques disclosed in Japanese Laid-Open Patent Publication (Kokai) No. 2023-129928 and Japanese Laid-Open Patent Publication (Kokai) No. 2007-129824, it is possible to reduce the guide resistance.

The technique disclosed in Japanese Laid-Open Patent Publication (Kokai) No. 2023-129928 has a problem that the number of components is increased, and a problem that the size of the lens barrel as the product is increased, and further, the weight of the same is liable to be increased. Further, the technique disclosed in Japanese Laid-Open Patent Publication (Kokai) No. 2007-129824 has a problem that the engagement portion, which is engaged with the guide bar, of the lens holder and the linear actuator are arranged side by side in the optical axis direction which is the linear driving direction, and hence the size of the lens barrel is liable to be increased in the linear driving direction.

### SUMMARY

The present disclosure is directed to providing a linear drive device that is low in guide resistance and prevents a product including the linear drive device from being increased in size and weight.

In a first aspect of the present disclosure, there is provided a linear drive device including a driven body, a linear guide that supports the driven body in a state movable in a first direction, and a linear actuator that drives the driven body in the first direction, wherein the linear guide has a hollow cylindrical shaft having an internal space extending in the first direction, wherein the linear actuator has a field part having a permanent magnet and a yoke, and a coil part having coils, wherein the field part is arranged in the internal space of the shaft, wherein the coil part is arranged coaxially with the shaft with a fixed spacing between inner peripheral surfaces of the coils and an outer peripheral surface of the shaft, wherein the driven body has two main engagement portions which are arranged with a certain spacing in the first direction and are slidably engaged with the shaft, and wherein sliding surfaces of the main engagement portions, which are slidably engaged with the shaft, have a comb-tooth shape which is intermittently brought into contact with the outer peripheral surface of the shaft in a circumferential direction.

In a second aspect of the present disclosure, there is provided a lens barrel including the linear drive device, wherein the driven body is a lens assembly in which a focus lens or a zoom lens is fixed to a lens holder.

Features of the present disclosure will become apparent from the following description of embodiments with reference to the attached drawings. The following description of embodiments are described by way of example.

### BRIEF DESCRIPTION OF THE DRAWINGS

FIG. 1 is a view showing a schematic configuration of an image capturing system according to an embodiment of the present technique.

FIG. 2 is an exploded perspective view showing a schematic configuration of a linear drive device according to a first embodiment.

FIGS. 3A and 3B are a perspective view of essential parts and a cross-sectional view of the whole of the linear drive device according to the first embodiment, respectively.

FIGS. 4A and 4B are respective perspective views of essential parts of linear drive devices according to first and second reference examples.

FIGS. 5A-5C are views each showing a schematic configuration of the linear drive device according to the second reference example.

FIGS. 6A-6E are views useful in explaining forces acting on a lens assembly when driving the lens assembly and a configuration of the lens assembly of the linear drive device according to a second embodiment.

### DESCRIPTION OF THE EMBODIMENTS

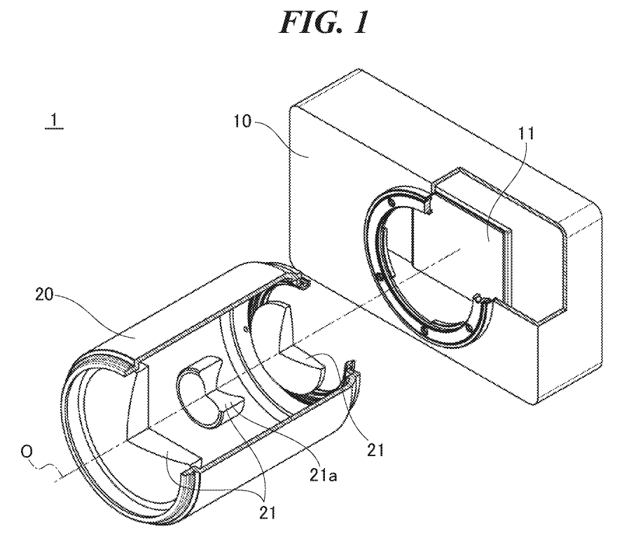

The present disclosure will now be described in detail below with reference to the accompanying drawings showing embodiments thereof. FIG. 1 is a view showing a schematic configuration of an image capturing system 1 according to a first embodiment. The image capturing system 1 is formed by an image capturing apparatus 10 and a lens barrel 20 which can be removably attached to the image capturing apparatus 10. Note that the image capturing apparatus 10 and the lens barrel 20 can be integrally configured, i.e., can be configured such that the lens barrel 20 cannot be removably attached, and in this case, “the image capturing apparatus” is referred to as “the image capturing apparatus body”, and “the image capturing system” is referred to as “the image capturing apparatus”.

The image capturing apparatus 10 is a so-called lens-interchangeable-type digital camera and includes an image sensor 11, such as a CMOS sensor. The lens barrel 20 is one generally referred to as the interchangeable lens and includes a lens group 21. The lens barrel 20 has a mount portion having a known structure, such as a bayonet engagement structure, and is configured to be removably attachable to the image capturing apparatus 10 such that a photographing optical axis O of the lens group 21 passes through the center of an imaging surface of the image sensor 11. Incident light passing through the inside of the lens barrel 20 forms an optical image on the imaging surface of the image sensor 11, and the image sensor 11 converts the optical image to electrical signals (image signals). Note that the image capturing apparatus 10 can be a conventional apparatus using a known technique, and detailed description of the configuration of the image capturing apparatus 10 is omitted.

The lens barrel 20 is configured to be capable of executing focusing for bringing an object into focus by driving a linear actuator to advance and retreat (move forward and backward) a focus lens 21a as one of the lenses forming the lens group 21 in an optical axis direction. The lens barrel 20 is configured to be capable of executing zooming for adjusting an angle of view by driving a linear actuator to advance and retreat a zoom lens as one of the lenses forming the lens group 21 in the optical axis direction. Note that the optical axis direction refers to a direction in which the photographing optical axis O extends.

A lens drive device for performing focusing and a lens drive device for performing zooming can have the same configuration. Hereafter, the lens drive device for performing focusing will be described.

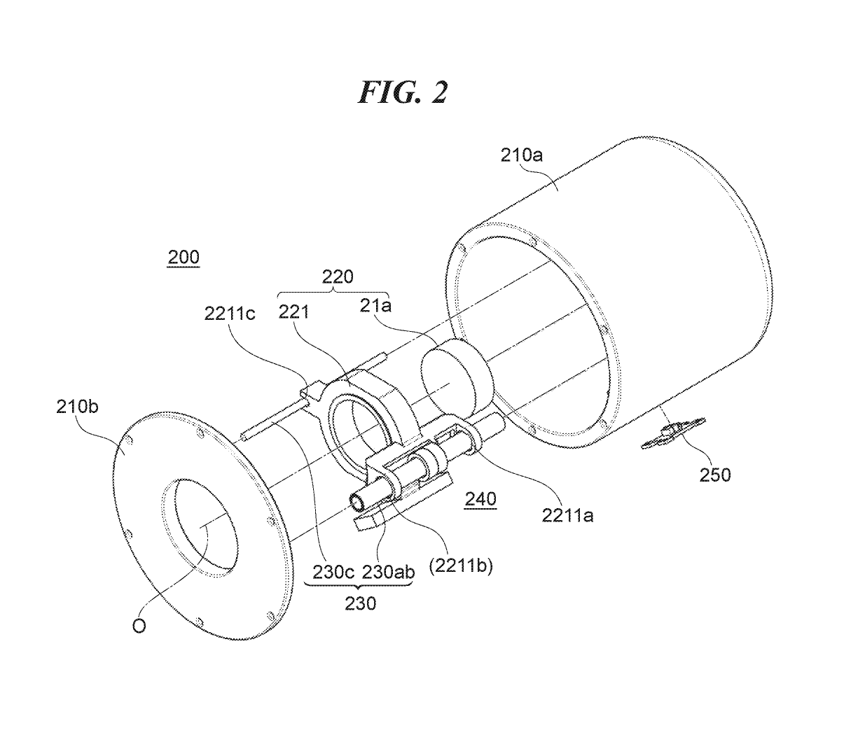

FIG. 2 is an exploded perspective view showing a schematic configuration of a linear drive device 200 arranged within the lens barrel 20, as the lens drive device for performing focusing. The linear drive device 200 includes the focus lens 21a, a lens holder 221, a rear base member 210a, a front base member 210b, a main guide shaft 230ab, a sub guide bar 230c, a linear actuator 240, and a linear encoder 250.

The rear base member 210a and the front base member 210b form a base body (so-called fixed barrel) of the linear drive device 200. The lens holder 221 is a holding member for holding the focus lens 21a, and the focus lens 21a is fixed to the lens holder 221 by bonding, caulking, or a like method. Note that the photographing optical axis O is also a virtual line passing through the center of the focus lens 21a.

In the following description, the lens holder 221 to which the focus lens 21a is fixed is referred to as the “lens assembly 220”. The focus lens 21a is defined as an object to be driven by the linear drive device 200, and the lens assembly 220 is defined as a driven body for the linear drive device 200.

The main guide shaft 230ab and the sub guide bar 230c are arranged on respective opposite sides of the lens holder 221 with a fixed distance therebetween such that directions of the lengths thereof are substantially parallel to the photographing optical axis O, thereby forming a linear guide 230. The opposite ends of the main guide shaft 230ab and the sub guide bar 230c in the length direction are fixed to the rear base member 210a and the front base member 210b, respectively. The sub guide bar 230c is a solid shaft member (bar). The main guide shaft 230ab is a hollow cylindrical bar, and in its hole part (internal space), a field part FM, described hereinafter, forming the linear actuator 240 is provided.

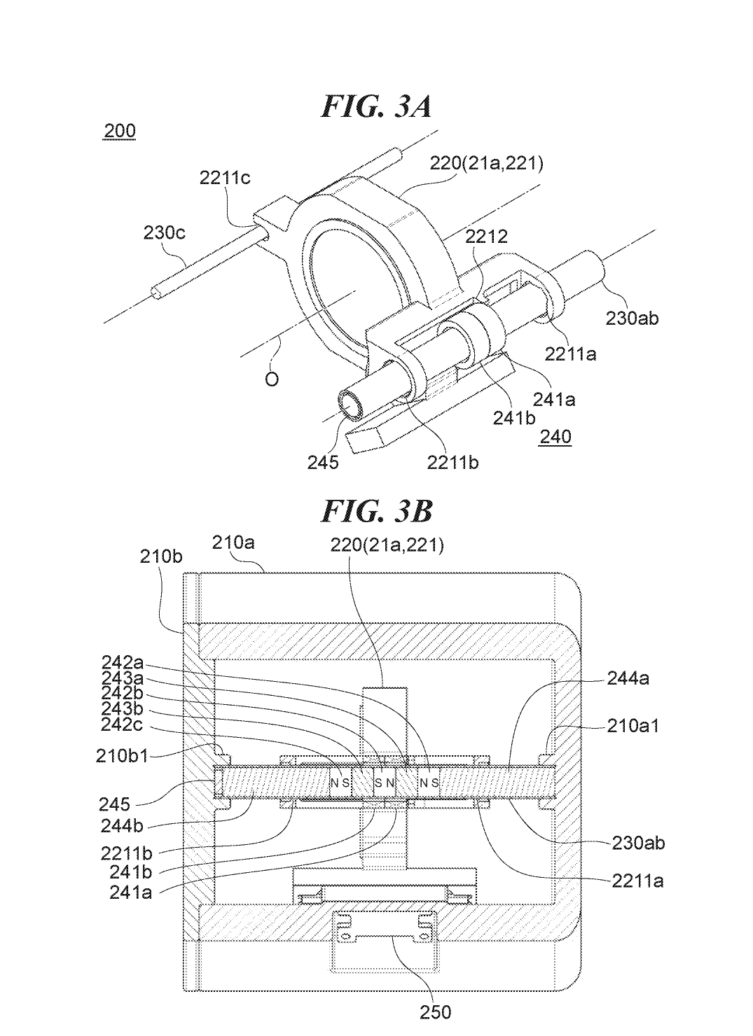

The lens holder 221 is formed with main engagement portions 2211a and 2211b, which are slidably engaged with the main guide shaft 230ab, and a sub engagement portion 2211c which is slidably engaged with the sub guide bar 230c. Since the main engagement portions 2211a and 2211b are engaged with the main guide shaft 230ab, and the sub engagement portion 2211c is engaged with the sub guide bar 230c, the lens assembly 220 is supported by the linear guide 230 in a state movable in the optical axis direction. Note that the lens holder 221 is formed with a coil holding portion 2212 (see FIGS. 3A and 3B) for positioning coils 241a and 241b (see FIGS. 3A and 3B) in the optical axis direction (linear driving direction (first direction)).

The linear actuator 240 is an electromagnetic linear DC motor. The linear actuator 240 will be described in detail hereinafter but will be simply described here. The linear actuator 240 roughly has a structure in which a field part including a plurality of permanent magnets arranged inside the main guide shaft 230ab and a substantially hollow cylindrical-shaped coil part formed by a plurality of coils are coaxially arranged. With this, the linear actuator 240 has characteristics that an axis of action when extracting, as the thrust, the Lorentz force generated by energizing the coil part is substantially parallel to the linear driving direction.

In the following description, the field part and the coil part of the linear actuator 240 are referred to as the “field part FM” and the “coil part CP”, respectively. Note that as will be described hereinafter with reference to FIGS. 3A and 3B, the field part FM is formed by permanent magnets 242a, 242b, and 242c, and yokes 243a and 243b, and the coil part CP is formed by the coils 241a and 241b.

The field part FM and the coil part CP are coaxially arranged with a fixed spacing between an outer peripheral surface of the main guide shaft 230ab containing the field part FM and an inner peripheral surface of the coil part CP. The field part FM is fixed inside the main guide shaft 230ab, and the coil part CP is fixed to the lens holder 221. A known technique can be used for wiring for driving the linear actuator 240 (wiring of e.g. power feeder to the coil part CP, and configuration and arrangement of a driving circuit), and hence illustration and description thereof is omitted.

The linear encoder 250 is attached to the rear base member 210a and detects a position of the lens assembly 220 in the optical axis direction with respect to the rear base member 210a (and the front base member 210b).

FIG. 3A is a perspective view showing the arrangement of essential parts of the linear drive device 200, in which the lens assembly 220, the main guide shaft 230ab, the sub guide bar 230c, and the linear actuator 240 are illustrated. FIG. 3B is a whole cross-sectional view of the linear drive device 200, illustrating a cross-section cut along a plane which passes the central axis of the main guide shaft 230ab and is orthogonal to a plane including the photographing optical axis O and the central axis of the main guide shaft 230ab.

The main engagement portions 2211a and 2211b of the lens holder 221 each are formed into a substantially hollow cylindrical shape at respective locations spaced from each other by a fixed distance (main guide baseline length) in the optical axis direction, which is the linear driving direction, and are slidably engaged with (fitted on) the main guide shaft 230ab. That is, the main guide shaft 230ab is in a state inserted through the holes of the main engagement portions 2211a and 2211b in the linear driving direction. With this arrangement, it is possible to regulate movement of the lens assembly 220, in total four directions, i.e. two directions, orthogonal to each other, of components of translational movement within a plane perpendicular to the linear driving direction, and pitching and yawing movements with respect to the linear driving direction.

The sub engagement portion 2211c has a groove shape having a certain length in the linear driving direction and is slidably engaged with (fitted on) the sub guide bar 230c. A direction in which two side walls forming the groove shape of the sub engagement portion 2211c are opposed to each other (direction perpendicular to the side walls surface) is substantially orthogonal to a plane including the central axis of the main guide shaft 230ab and the central axis of the sub guide bar 230c. With this, it is possible to prevent rotation (roll) of the lens assembly 220 about the main guide shaft 230ab.

Therefore, the lens assembly 220 is regulated from moving in total five directions except the linear driving direction, by a combination of the main guide shaft 230ab and the main engagement portions 2211a and 2211b, and a combination of the sub guide bar 230c and the sub engagement portion 2211c. Further, the directions regulated by the respective combinations do not overlap, and hence it is possible to reduce an influence applied by shapes and an arrangement error of the components on variation of performance as much as possible.

The linear actuator 240 has the coils 241a and 241b each having a hollow cylindrical shape, and the coils 241a and 241b are fixed to the coil holding portion 2212 formed on the lens holder 221, and their positions in the linear driving direction are regulated. The main guide shaft 230ab is inserted through the holes of the coils 241a and 241b such that the coils 241a and 241b and the main guide shaft 230ab are substantially coaxial with each other.

The linear actuator 240 includes the permanent magnets 242a, 242b, and 242c, which are arranged inside the main guide shaft 230ab, the yokes 243a and 243b, filling members 244a and 244b, and a cushioning member 245. The permanent magnets 242a, 242b, and 242c, and the yokes 243a and 243b each have a solid cylindrical shape, the yoke 243a is arranged between the permanent magnets 242a and 242b, and the yoke 243b is arranged between the permanent magnets 242b and 242c. The filling members 244a and 244b are members for holding the permanent magnets 242a-242c, and the yokes 243a and 243b, in respective predetermined positions inside the main guide shaft 230ab. The cushioning member 245 is a member for biasing and positioning the permanent magnets 242a to 242c, the yokes 243a and 243b, and the filling members 244a and 244b, inside the main guide shaft 230ab. Note that the number of components forming the linear actuator 240 is not limited to the number illustrated in FIGS. 3A and 3B.

The linear actuator 240 has the configuration of a so-called in-coil magnet arrangement type, in which the field part FM extends in the linear driving direction and at the same time is positioned inside the coil part CP on a projection plane as viewed from the linear driving direction, and is characterized in compactness and lightweight. Further, although details will be described hereinafter, in the linear actuator 240, the central axis of the coil part CP as a thrust generation point, and the central axis of the main guide shaft 230ab can be regarded as overlapping each other on an optical axis projection plane. Note that the optical axis projection plane refers to a virtual plane perpendicular to the photographing optical axis O as viewed from a direction in which the photographing optical axis O extends, and the phrase “is regarded as overlapping” is intended to mean “overlaps” or “is close”. With this, it is possible to reduce the guide resistance and obtain sufficient driving performance even by a single actuator.

The variety of components forming the linear actuator 240 will be further described. The main guide shaft 230ab is a thin (small in thickness) hollow cylindrical bar, and is formed of a material which is nonmagnetic and at the same time has high mechanical strength, such as copper alloy or aluminum alloy. The main guide shaft 230ab is manufactured by a variety of processing methods, such as grinding, extrusion, and drawing. The main guide shaft 230ab is a main component of the linear guide 230 of the lens assembly 220 and hence is desirable to be processed with high accuracy with respect to a size tolerance, straightness, surface roughness, and so forth.

By forming the main guide shaft 230ab as a thin guide shaft, it is possible to increase the diameter of the internal field part FM large, and at the same time reduce a distance between the field part FM and the coil part CP. As a result, it is possible to increase an interlinkage magnetic flux acting on the coil part CP and increase the output power of the linear actuator 240.

The coils 241a and 241b are fixed to the lens holder 221 e.g. by bonding at respective locations with a fixed spacing from the inner peripheral surface of the coils 241a and 241b and at the same time is substantially coaxial with the main guide shaft 230ab. Note that by providing the coil holding portion 2212 on the lens holder 221, when the linear actuator 240 is assembled, it is possible to easily position and fix the coil part CP (the coils 241a and 241b).

In the linear actuator 240, the two coils 241a and 241b as an example of the plurality of coils are arranged side by side in the linear driving direction, and energization of the coils 241a and 241b is controlled according to a stroke position. With this, it is possible to obtain desired thrust at a desired position within the stroke range with a stable efficiency.

The field part FM is formed to have an outer diameter substantially equal to the inner diameter of the main guide shaft 230ab so as to prevent the field part FM from being loosened (moved) in a direction perpendicular to the photographing optical axis O inside the main guide shaft 230ab. The permanent magnets 242a-242c, and the yokes 243a and 243b are alternately arranged in the linear driving direction inside the main guide shaft 230ab, and at the same time, the permanent magnets 242a-242c are arranged such that the same poles are opposed to each other. This arrangement is a so-called multi magnetic pole-type arrangement in which the field part FM is arranged such that the polarity of the interlinkage magnetic flux acting on the coil part CP within a fixed stroke range in the linear driving direction periodically changes. This arrangement has advantages that the influence of magnetic saturation is small and it is possible to extend the stroke range by forming a periodic structure, and further, the field part FM is only required to be disposed only on a part corresponding to the driving range of the linear actuator.

The filling members 244a and 244b are arranged in portions in which the length of the field part FM in the optical axis direction is insufficient to the length of the main guide shaft 230ab in the optical axis direction. Further, similar to the field part FM, the filling members 244a and 244b each also have an outer diameter substantially equal to the inner diameter of the main guide shaft 230ab so as to prevent the filling members 244a and 244b from being loosened inside the main guide shaft 230ab. As the material of the filling members 244a and 244b, a material is used which is smaller in density (specific gravity) than the permanent magnets and the yokes, forming the field part FM, and is low in costs, whereby it is possible to reduce the weight and costs. By fixing the filling members 244a and 244b inside the main guide shaft 230ab by using an adhesive, it is also possible to obtain the effect of complementing the strength of the main guide shaft 230ab as the linear guide. In the linear actuator 240, the filling members 244a and 244b are arranged to sandwich the field part FM but are not necessarily required to be arranged on both sides of the field part FM, and depending on a position where the field part FM is fixed, only one of them can be provided on one side of the field part FM.

The rear base member 210a and the front base member 210b are formed with first press-fitting portions 210a1 and 210b1 for press-fixing the main guide shaft 230ab, respectively, and are also formed with second press-fixing portions (not shown) for press-fixing the sub guide bar 230c, respectively.

To assemble the linear drive device 200, first, the main guide shaft 230ab is press-fitted in the first press-fixing portion 210a1 and fixed. Then, the permanent magnets 242a to 242c, the filling members 244a and 244b, and the cushioning member 245 are inserted into the press-fixed main guide shaft 230ab in a predetermined order. At this time, it is necessary to position and fix the field part FM in accordance with the driving range requested to the linear drive device 200. In the linear actuator 240, the filling member 244a is brought into abutment with the rear base member 210a. That is, the field part FM is positioned by arranging the filling member 244a in an area from one end of the main guide shaft 230ab to the field part FM. Note that positioning of the field part FM can be performed by bringing the filling member 244b into abutment with the front base member 210b. Further, the sub guide bar 230c is press-fitted in the second press-fixing portion (not shown) formed in the rear base member 210a and fixed.

Separately, the lens assembly 220 is made in advance in which the focus lens 21a is fixed to the lens holder 221, and the coils 241a and 241b are fixed to the coil holding portion 2212 of the lens holder 221 in the lens assembly 220 in advance.

Then, the lens assembly 220 to which the coils 241a and 241b are fixed is assembled to the main guide shaft 230ab and the sub guide bar 230c in the linear driving direction from the opening end side of the main guide shaft 230ab and the sub guide bar 230c. Thus, the main guide shaft 230ab is inserted through the main engagement portions 2211a and 2211b, and the coils 241a and 241b, and the sub guide bar 230c is engaged with the sub engagement portion 2211c. Finally, the opening ends of the main guide shaft 230ab and the sub guide bar 230c are press-fitted in and fixed to the first press-fixing portion 210b1 and the second press-fixing portion of the front base member 210b, respectively, whereby the linear drive device 200 is assembled.

Note that in the linear actuator 240, the cushioning member 245 having elasticity, such as sponge or rubber, is arranged on a side of the main guide shaft 230ab, toward the front base member 210b. The cushioning member 245 presses (urges) the filling member 244b toward the field part FM, whereby it is possible to increase the accuracy of positioning the field part FM in the linear driving direction. Thus, the linear drive device 200 has characteristics that it is possible to easily assemble the linear actuator 240 and at the same time dispose the coil part CP and the field part FM with high accuracy.

Incidentally, in the multi-pole type field part in which a plurality of permanent magnets are arranged such that the same poles are opposed to each other in the linear driving direction, a force causing displacement in a direction perpendicular to the linear driving direction is generated in the permanent magnets due to repulsion of magnetic forces. To cope with this, conventionally, for example, the field part is formed into a hollow cylindrical shape, and a shaft body for fixing the field part is inserted through a hole of the field part to bind and hold components of the field part. However, this configuration has a problem that a magnetic flux as the power source of the linear actuator becomes small due to reduction of the volume of the permanent magnets.

On the other hand, in the linear actuator 240, the components of the field part FM, each having the same outer diameter as the inner diameter of the main guide shaft 230ab, are inserted into the main guide shaft 230ab to assemble the field part FM. Therefore, positional displacement of the permanent magnets in a direction perpendicular to the linear driving direction, caused by repulsion of magnetic forces of the permanent magnets, can be prevented by the main guide shaft 230ab. Further, it is possible to form the permanent magnets 242a-242c into the cylindrical shape (disk shape), and although a space between the field part FM and the coil part CP is increased by the thin thickness of the main guide shaft 230ab, it is possible to improve the output power more than the conventional configuration.

Note that in the linear actuator 240, by using the main guide shaft 230ab integrating the main linear guide bar having a simple shape and the shaft member for fixing the field part, which are required as separate components in the conventional configuration, it is possible to save the space and reduce the number of components.

Next, the characteristics of the linear drive device 200 according to the first embodiment will be described, in comparison with a configuration of a linear drive device according to reference examples created based on the conventional technique.

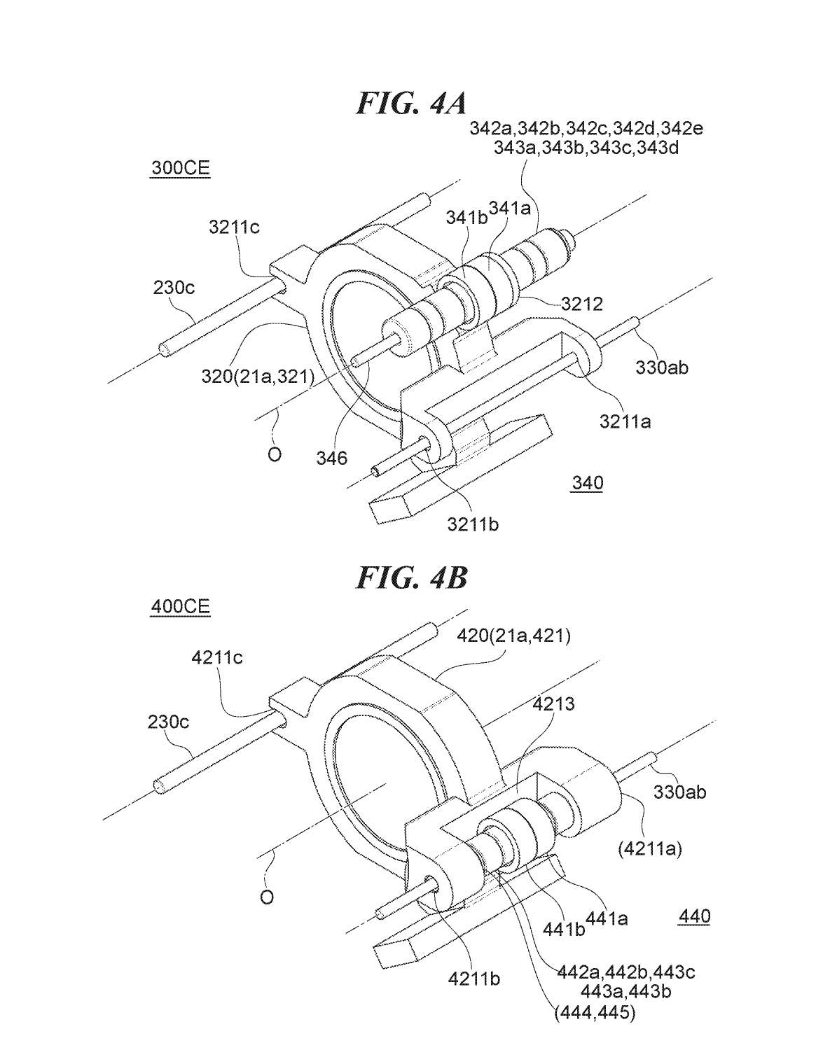

FIG. 4A is a perspective view of essential parts of a linear drive device 300CE according to a first reference example. The linear drive device 300CE uses a main guide bar 330ab formed by a solid shaft member, similar to that used for a sub guide bar 230c, and is configured such that a linear actuator 340 does not overlap the main guide bar 330ab on the optical axis projection plane. Note that the phrase “not overlap on an optical axis projection plane” is intended to mean “not overlap when viewed from a direction in which the photographing optical axis O extends”.

FIG. 4B is a perspective view of essential parts of a linear drive device 400CE according to a second reference example. The linear drive device 400CE differs from the linear drive device 300CE in that a linear actuator 440 is arranged such that the linear actuator 440 overlaps the main guide bar 330ab, which is the same as that used for the linear drive device 300CE, on an optical axis projection plane.

The same components of the linear drive devices 300CE and 400CE according to the first and second reference examples as the components of the linear drive device 200 are denoted by changing a value of the top (the thousands digit or the hundreds digit) of each reference numeral, from “2” in the linear drive device 200 to “3”- “4”. For example, lens holders 321 and 421 correspond to the lens holder 221, and description of the components, which are different only in the leading digit value of the reference numeral, is omitted. Further, the principle of thrust generation in the linear drive devices 300CE and 400CE according to the first and second reference examples is the same as that of the linear drive device 200 according to the first embodiment, and hence description thereof is omitted.

First, the linear drive device 200 according to the first embodiment and the linear drive device 300CE according to the first reference example will be compared. In the linear drive device 300CE, a solid shaft member which is made of metal and has a small diameter is used for the main guide bar 330ab as the main guide, and main engagement portions 3211a and 3211b of a lens assembly 320 are slidably engaged with the main guide bar 330ab. The form of engagement between a sub engagement portion 3211c and the sub guide bar 230c is the same as the form of engagement between the sub engagement portion 2211c and the sub guide bar 230c of the linear drive device 200.

The linear actuator 340 as a component of the linear drive device 300CE includes coils 341a and 341b, permanent magnets 342a, 342b, 342c, 342d, and 342e, yokes 343a, 343b, 343c, and 343d, and a field part-fixing shaft 346. The coils 341a and 341b are fixed to a coil holding portion 3212 of the lens holder 321 e.g. by bonding such that a fixed distance is held between the inner peripheral surfaces thereof and the outer peripheral surfaces of the permanent magnets 342a-342e and the yokes 343a-343d and at the same time the central axis thereof is substantially parallel to the photographing optical axis O.

The permanent magnets 342a-342e and the yokes 343a-343d each have a substantially hollow cylindrical shape, and inner diameters of these are substantially the same. The linear actuator 340 differs from the linear actuator 240 in the number of components, but is the same as the linear actuator 240 in the array of the components of the field part FM. That is, the permanent magnets 342a-342e and the yokes 343a-343d are arranged alternately and at the same time such that that the same poles of the permanent magnets 342a-342e are opposed to each other in the linear driving direction. In this case, as described above, a force causing displacement in a direction perpendicular to the linear driving direction is generated in the permanent magnets 342a-342e due to repulsion of magnetic forces. To prevent this, the field part-fixing shaft 346 having substantially the same outer diameter as the inner diameters of the permanent magnets 342a-342e and the yokes 343a-343d is inserted through holes of the permanent magnets 342a-342e and the yokes 343a-343d.

In the linear drive device 300CE, the linear actuator 340 is arranged such that it overlaps neither a focus lens 21a, the main guide bar 330ab, the sub guide bar 230c, nor the like (hereinafter referred to as the “essential structure parts”) on an optical axis projection plane. In this case, although details will be described hereinafter, as the linear actuator 340 is more remote from the main guide bar 330ab, the guide resistance is increased more.

In the linear drive device 200 according to the first embodiment, a hollow thin pipe is used for the main guide shaft 230ab as the main guide, compared with the linear drive device 300CE according to the first reference example. This makes it possible to arrange the linear actuator 240 substantially coaxially with the main guide shaft 230ab on the optical axis projection plane, and hence it is possible to reduce the guide resistance when the lens assembly 220 is moved in the linear driving direction. Further, in the linear drive device 200, compared with the linear drive device 300CE, parts and members arranged around (outside) the focus lens 21a are less, and hence it is possible to reduce the size and costs of the lens barrel 20. Further, since the field part FM is fixed inside the main guide shaft 230ab, it is possible to reduce the number of components and easily assemble the lens barrel 20.

From the description given above, it is understood that, compared with the linear drive device 300CE according to the first reference example, the linear drive device 200 according to the first embodiment is superior in size reduction of the product (lens barrel), reduction of the number of components, reduction of the guide resistance, and easiness of assembly.

Next, the linear drive device 200 according to the first embodiment and the linear drive device 400CE according to the second reference example will be compared.

Similar to the lens assembly 320 of the linear drive device 300CE, a lens assembly 420 of the linear drive device 400CE is arranged in a state movable in the optical axis direction by using the main guide bar 330ab and the sub guide bar 230c as the linear guide. A main opening 4213 is formed between two main engagement portions 4211a and 4211b, formed on the lens holder 421, and the linear actuator 440 is accommodated in the main opening 4213.

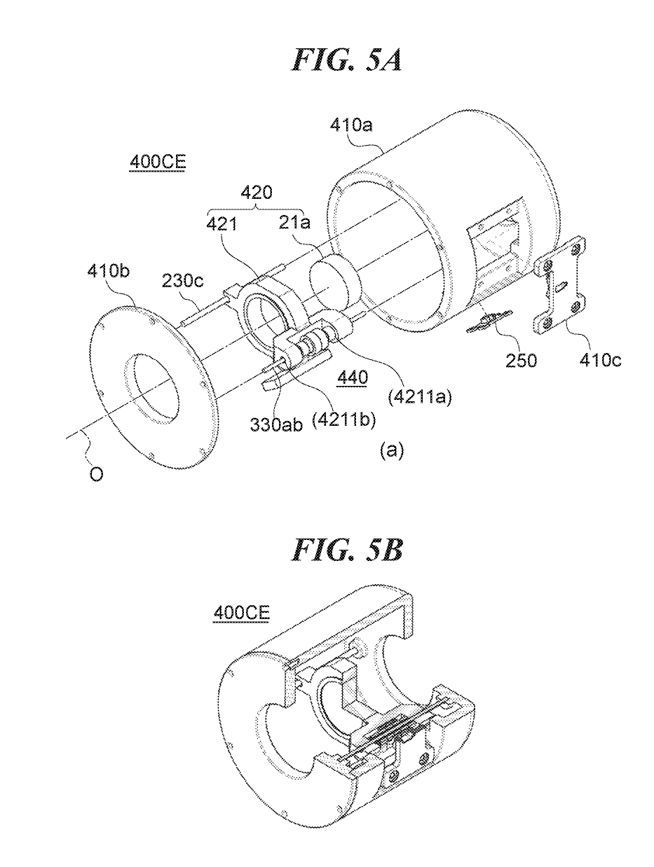

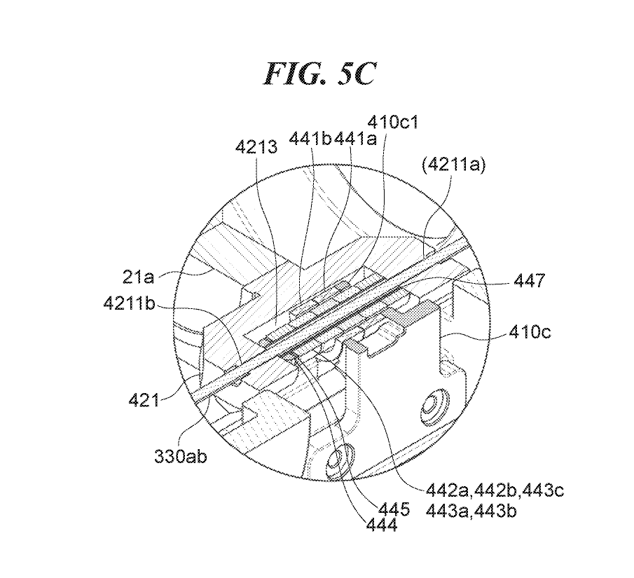

The linear actuator 440 includes coils 441a and 441b, permanent magnets 442a, 442b, and 442c, yokes 443a and 443b, a filling member 444, a cushioning member 445, and a field part-fixing pipe 447 (invisible in FIG. 4B, see FIG. 5C).

The coils 441a and 441b are arranged such that a fixed distance is held between the inner peripheral surfaces thereof and the outer peripheral surfaces of the permanent magnets 442a-442c and the yokes 443a and 443b, and at the same time such that the central axis thereof is substantially coaxial with the main guide bar 330ab. In the linear drive device 300CE according to the first reference example, the coils 341a and 341b are moved in the linear driving direction in unison with the lens holder 321. On the other hand, in the linear drive device 400CE, the permanent magnets 442a-442c, and the yokes 443a and 443b are moved in the linear driving direction in unison with the lens holder 421.

In the linear actuator 440, a thrust generation point can be regarded to overlap the main guide bar 330ab on an optical axis projection plane, and hence the guide resistance can be reduced more than in the case of the linear drive device 300CE.

The permanent magnets 442a-442c and the yokes 443a and 443b each have a hollow cylindrical shape, and have inner diameters which are substantially the same, and the main guide bar 330ab is inserted through the holes of these. Note that the magnetic arrangement of the permanent magnets 442a-442c and the yokes 443a and 443b is the same as the magnetic arrangement of the permanent magnets 242a-242c and the yokes 243a and 243b in the linear actuator 240.

In the linear actuator 440, the field part-fixing pipe 447 (see FIG. 5C) formed of a nonmagnetic material is used to prevent displacement of the permanent magnets 242a-242c in a direction perpendicular to the photographing optical axis O. An outer diameter of the field part-fixing pipe 447 is substantially the same as the inner diameters of the permanent magnets 442a-442c and the yokes 443a and 443b, and an inner diameter of the field part fixing pipe 447 is larger than an outer diameter of the main guide bar 330ab. In the linear actuator 440, the permanent magnets 442a-442c and the yokes 443a and 443b are positioned and fixed between the main engagement portions 4211a and 4211b of the lens holder 421 by using the field part-fixing pipe 447.

Here, limitation applied to the shape of the field part-fixing pipe 447 will be described. If the outer diameter of the field part-fixing pipe 447 is increased, the inner diameters of the permanent magnets 442a-442c are increased and the volume of the permanent magnets 442a-442c is reduced, whereby the interlinkage magnetic flux acting on the coils 441a and 441b is reduced, which reduces the output power. Even when the inner diameter of the field part-fixing pipe 447 is reduced to solve this problem, there is a limitation from the viewpoint of avoiding increase in the guide resistance caused by contact between the inner peripheral surface of the field part-fixing pipe 447 and the outer peripheral surface of the main guide bar 330ab. That is, it is necessary to form a certain spacing between the inner peripheral surface of the field part-fixing pipe 447 and the outer peripheral surface of the main guide bar 330ab.

Therefore, the outer diameter of the field part-fixing pipe 447 is obtained by “the outer diameter of the main guide bar 330ab” + “the spacing between the outer peripheral surface of the main guide bar 330ab and the inner peripheral surface of the field part-fixing pipe 447” + “the thickness of the field part-fixing pipe 447”. All of these three terms have respective limitations in the points of working or dynamics (mechanical strength) and functions, and hence, it is difficult to largely reduce the diameter of the field part-fixing pipe 447. For this reason, in the linear actuator 440, compared with the permanent magnets 342a-342e of the linear actuator 340, the volume of the permanent magnets 442a-442c is reduced, and hence lowering of the output power is inevitable.

Compared with the linear drive device 400CE according to the second reference example, which is configured as described above, the linear driving device 200 according to the first embodiment makes it possible to reduce the guide resistance, by causing the thrust generation point to overlap with the main guide shaft 230ab on the optical axis projection plane. Further, by forming the permanent magnets 242a-242c into the solid cylindrical shape, it is possible to secure the volume of the magnets. With these, it is possible to increase the output efficiency, and further, it is possible to obtain large output power.

Compared with the linear drive device 400CE according to the second reference example, the linear drive device 200 according to the first embodiment is superior in actuator stroke (hereinafter simply referred to as the “stroke”) and the assemblability, and this point will be described below.

FIG. 5A is an exploded perspective view showing the schematic configuration of the linear drive device 400CE according to the second reference example. FIG. 5B is a perspective view, partially in cross-section, of the linear drive device 400CE. FIG. 5C is an enlarged view of part of the cross section shown in FIG. 5B. Note that the method of adding the reference numerals to the components of the linear drive device 400CE in FIGS. 5A-5C is based on the method of adding the reference numerals in FIGS. 4A and 4B.

The linear drive device 400CE has, as the base body, not only the rear base member 210a and the front base member 210b, but also a side base member 410c. The side base member 410c has a coil holding portion 410c1 equivalent to the coil holding portion 3212 of the lens holder 321 as a component of the linear drive device 300CE according to the first reference example.

When the linear drive device 400CE is assembled, first, the coils 441a and 441b are fixed to the side base member 410c e.g. by bonding. Next, the lens assembly 420 and the linear actuator 440 are arranged in the state shown in FIG. 4B with respect to the rear base member 410a. Then, the side base member 410c to which the coils 441a and 441b are fixed is fixed to the rear base member 410a e.g. with screws. After that, the lens assembly 420 is fixed to part of the linear actuator 440, other than the coils 441a and 441b, e.g. by bonding, but before doing this, the lens assembly 420 and the linear actuator 440 have not been fixed to each other yet, and further it is required to perform the bonding operation inside the rear base member 410a, and hence the assembling difficulty is high. Finally, the main guide bar 330ab and the sub guide bar 230c are fixed to the rear base member 410a e.g. by press-fitting through all holes and fixed to the front base member 410b e.g. with screws, whereby the linear drive device 400CE is completed.

In contrast, the linear drive device 200 according to the first embodiment can be assembled by sequentially disposing the components in the linear driving direction, as described above, and hence it is very easy to assemble the linear drive device 200.

The configuration of the linear drive device 400CE in which the linear actuator 440 is arranged between the main engagement portions 4211a and 4211b of the lens holder 421 limits the stroke. The stroke range of the linear actuator 440 is a range from a position where the coil holding portion 410c1 is brought into abutment with the side wall, on a side toward the main engagement portion 4211a, of the main opening 4213 to a position where the coil 441b is brought into abutment with the side wall, on a side toward the main engagement portion 4211b, of the main opening 4213. That is, the stroke of the linear actuator 440 is obtained by “the length of the main opening 4213 in the linear driving direction” – “the length of the coils 441a and 441b in the linear driving direction” – “the thickness of the coil holding portion 410c1 in the linear driving direction”.

If the lengths of the coils 441a and 441b in the linear driving direction are reduced, i.e., the coil volume is reduced, the stroke range can be extended, but the output power is lowered. Therefore, to extend the stroke range while maintaining the output power, it is necessary to extend the length of the main opening 4213 in the linear driving direction. The main opening 4213 is a space formed between the main engagement portions 4211a and 4211b, and a certain sliding area is needed for the main engagement portions 4211a and 4211b to secure the guide accuracy in linear driving. Therefore, to extend the stroke range, it is necessary to increase the main guide baseline length, but in this case, there is a problem that the lens holder 421 is increased in size in the linear driving direction, which increases the size of the lens barrel.

In contrast, in the linear drive device 200 according to the first embodiment, the stroke range of the linear actuator 240 is a range from a position where the lens holder 221 is brought into abutment with the rear base member 210a to a position where the lens holder 221 is brought into abutment with the front base member 210b. Therefore, by increasing the number of permanent magnets and the yokes, arranged inside the main guide shaft 230ab of the linear actuator 240, it is possible to unlimitedly extend the stroke range without increasing the size of the lens assembly 220.

As described above, it can be said that, compared with the linear drive device 400CE according to the second reference example, the linear drive device 200 according to the first embodiment is superior in the viewpoints of the output, the output efficiency, easiness in assembling, and the stroke range.

The description has been given heretofore of the configuration and the superiority of the linear drive device 200 according to the first embodiment. The linear drive device 200 uses the main guide shaft 230ab having the hollow cylindrical shape, thereby making it possible to reduce the guide resistance by causing the thrust generation point of the linear actuator 240 to overlap on the main guide shaft 230ab, on the optical axis projection plane. The description on this respect will be given next.

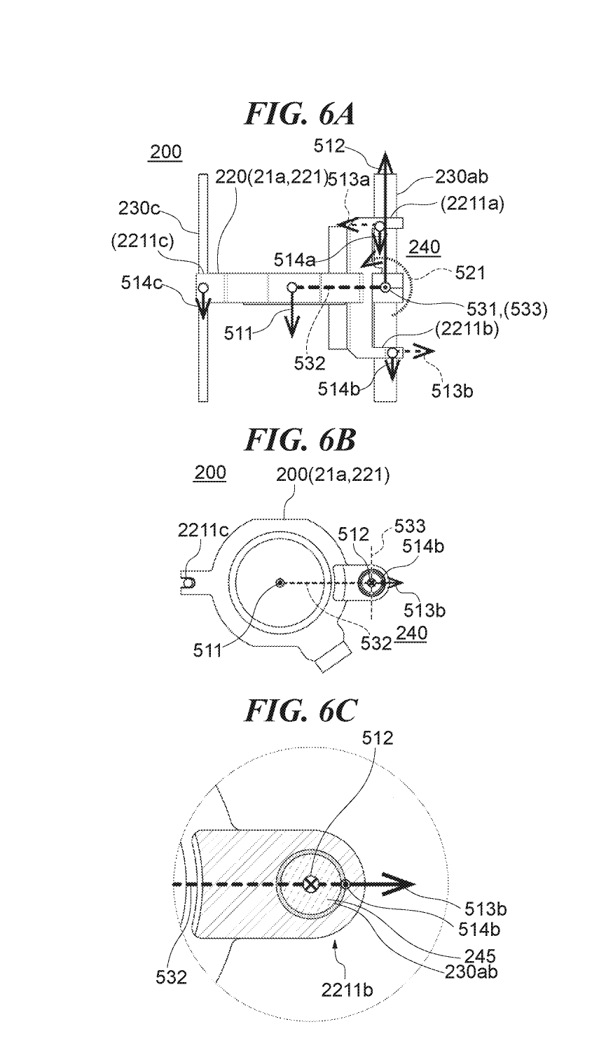

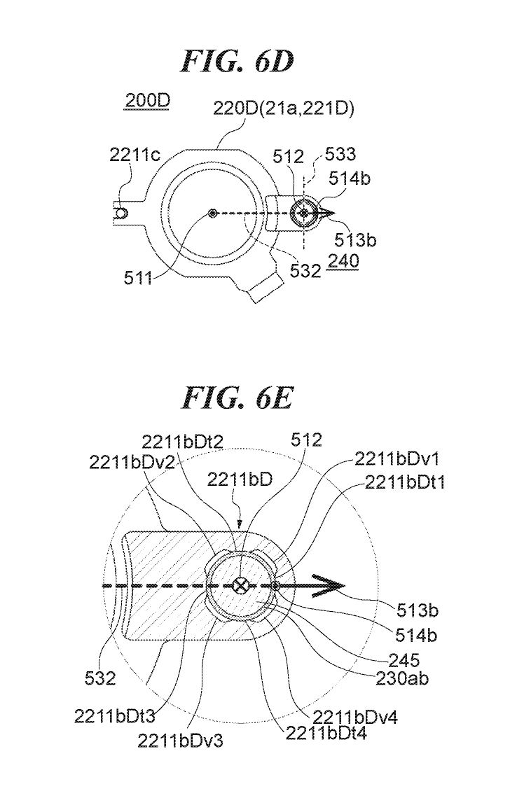

FIG. 6A is a top view of the linear drive device 200, in which are illustrated forces acting on the lens assembly 220 when driving the lens assembly 220 upward in a vertical direction against the gravity (hereinafter referred to as the “gravity climbing direction”). A force applied downward in the vertical direction (hereinafter referred to as the “gravity 511” for convenience), as the sum of the gravity and the inertia force, acts on the center of gravity of the lens assembly 220. A thrust 512 acts on the coil part CP, normal forces 513a and 513b act on the main engagement portions 2211a and 2211b, guide resistances 514a and 514b act on the main engagement portions 2211a and 2211b, and a guide resistance 514c acts on the sub engagement portion 2211c. Further, a rotational moment 521 also acts on the lens assembly 220.

Hereafter, a center point, in the linear driving direction, between the main engagement portions 2211a and 2211b which mainly regulate rotation of the lens assembly 220, is defined as the “virtual supporting point 531”, and a straight line connecting between the virtual supporting point 531 and the center of gravity of the lens assembly 220 is defined as the “gravity center transverse line 532”. Further, a plane including two straight lines of the central axis of the main guide shaft 230ab and the gravity center transverse line 532 is defined as the “gravity center transverse plane”, and a straight line passing the virtual supporting point 531 and orthogonal to the gravity center transverse plane is defined as the “lens rotational axis 533”.

The gravity 511 acting on the lens assembly 220 generates the rotational moment 521 about the lens rotational axis 533 as the central axis. The rotational moment 521 is generated due to a state in which the center of gravity on which the gravity 511 acts and the generation point of the thrust 512 are apart from each other, but the linear actuator 240 cannot be disposed on the center of gravity of the lens assembly 220. This is because another component cannot be disposed on a position overlapping the focus lens 21a on an optical axis projection plane. Therefore, the rotational moment 521 can be said as the moment which is inevitable in the linear drive device 200.

Sliding portions (contact portions) of the main guide shaft 230ab where the rotational moment 521 slide on a side, toward the photographing optical axis, of the main engagement portion 2211a, and on a side, opposite from the photographing optical axis, of the main engagement portion 2211b, respectively, are defined as the “main guide sliding surfaces”. Further, a sliding surface between the sub guide bar 230c and the sub engagement portion 2211c is defined as the “sub guide sliding surface”.

On the main guide sliding surface, the normal forces 513a and 513b are generated in a direction substantially parallel to the gravity center transverse line 532. The normal forces 513a and 513b generate frictional forces on the main guide sliding surfaces, which act in a direction opposite from the moving direction of the lens assembly 220. Further, in general, a lubricating material is applied to the main guide shaft 230ab to reduce sliding loads, and viscous forces acting in the moving direction are generated by the lubricating material and the above-mentioned frictional forces. These frictional forces and viscous forces form main components of the guide resistances 514a and 514b.

Similarly, although the guide resistance 514c is generated on the sub guide sliding surface, the guide resistance 514c is not a force generated due to the rotational moment 521 generated by the gravity 511. Therefore, compared with the guide resistances 514a and 514b acting on the main guide sliding surface, the guide resistance 514c is small, and an influence of the guide resistance 514c on all guide resistances is small.

The rotational moment 521 most strongly acts in a case where the lens assembly 220 is driven in the gravity climbing direction as shown in FIG. 6A, and the guide resistances 514a and 514b also become maximum in this situation. All of vectors of the forces of the gravity 511, the thrust 512, the normal forces 513a and 513b, and the guide resistances 514a-514c, which act on the lens assembly 220 when the lens assembly 220 is driven in the gravity climbing direction, are almost included in the gravity transverse surface. This is because the linear drive device 200 is configured such that the thrust generation point of the linear actuator 240 overlaps the main guide shaft 230ab on the optical axis projection plane.

In contrast, in the first reference example shown in FIG. 4A, the linear actuator 340 is arranged at a location whether the linear actuator 340 does not overlap the main guide bar 330ab on the optical axis projection plane. In this case, the normal force component in a direction of passing a linear guide plane (plane including the central axis of the main guide bar 330ab and the central axis of the sub guide bar 230c) is added, and hence the guide resistance is increased. In other words, in the linear drive device 200, reduction of the guide resistance is realized by suppressing the added amount of the guide resistance in the first reference example.

Finally, a configuration for reducing the frictional forces and the viscous forces as a factor causing the guide resistances 514a and 514b in the linear drive device will be described.

FIG. 6B is a simplified cross-sectional view of the essential parts of the linear drive device 200, and FIG. 6C is a partial enlarged view of a cross section of the main guide shaft 230ab in FIG. 6B, which is cut along a plane perpendicular to the linear driving direction, in the main engagement portion 2211b. FIG. 6D is a simplified cross-sectional view of essential parts of a linear drive device 200D according to a second embodiment, which is a view corresponding to FIG. 6B. FIG. 6E is a partial enlarged view of a cross section of the main guide shaft 230ab in FIG. 6D, which is cut along a plane perpendicular to the linear driving direction, in a main engagement portion 2211bD.

Note that, compared with the linear drive device 200, the linear drive device 200D differs therefrom only in the configuration of the main engagement portions formed on the lens holder, and is the same in the other configuration as the linear drive device 200. The components of the linear drive device 200D are each denoted by a reference numeral formed by adding “D” to the end of the reference numeral of each corresponding component of the linear drive device 200.

FIGS. 6B-6E show, similar to FIG. 6A, part of the forces acting on the lens assembly 220 when the lens assembly 220 is driven in the gravity climbing direction. The sliding surface between the main engagement portions 2211a and 2211b of the lens holder 221 and the main guide shaft 230ab is expressed by concentric circles on the optical axis projection plane, as shown in FIG. 6C.

If the sliding area between the main guide shaft 230ab and the main engagement portions 2211a and 2211b is increased, the guide resistance514b is liable to be increased by an increase in the frictional forces and the viscous forces. To avoid this, a main engagement portion, not shown, and the main engagement portion 2211bD of a lens holder 221D of the linear drive device 200D each have an inner peripheral surface as the sliding surface on the main guide shaft 230ab, which is formed into a comb-tooth shape, and is intermittently engaged with the outer peripheral surface of the main guide shaft 230ab in the circumferential direction. Note that the main engagement portion (not shown) has the same comb-tooth shape as the main engagement portion 2211bD.

A reason for forming the main engagement portion (not shown) and the main engagement portion 2211bD into the comb-tooth shape and an effect obtained by this will be described below by referring to the main engagement portion 2211bD as a representative. Note that the main engagement portion (not shown) has the same configuration as the main engagement portion 2211bD, and hence the same effects as provided by the main engagement portion 2211bD can be obtained thereby.

In the present embodiment, the comb-tooth shape refers to, as shown in FIG. 6E, a structure in which protruding portions 2211bDt1-2211bDt4 toward the central axis of the main guide shaft 230ab, and intermittent portions 2211bDv1-2211bDv4 between the protruding portions 2211bDt1-2211bDt4, are alternately formed in the circumferential direction. Note that each protruding end surface, brought into contact with the main guide shaft 230ab, of the protruding portions 2211bDt1-2211bDt4 has an arc shape, in cross-section cut along a plane perpendicular to the linear driving direction, as part of a circle about the central axis of the main guide shaft 230ab as the center.

Although the normal force 513b and the guide resistance 514b act on the main engagement portion 2211b of the linear drive device 200, particularly, the normal force 513b acts in a direction orthogonal to the linear driving direction in a portion where the gravity transverse line 532 and the main engagement portion 2211b intersect with each other. Specifically, in FIGS. 6D and 6E, the lens assembly 220D is driven in the gravity climbing direction, and the normal force 513b acts on the outer side of the main engagement portion 2211bD (the side opposite from the focus lens 21a).

On the other hand, if the driving direction is reversed (the gravity 511 and the thrust 512 are reversed), although not shown, all of the vectors of the forces and the moment in FIG. 6A are reversed, and the normal force 513b acts on the inside of the main engagement portion 2211bD (the side toward the focus lens 21a). The main engagement portion 2211b receives large stress at the point of action of the normal force 513b, and hence it is desirable to reduce the area of the main guide sliding surface while securing the component strength (load resistance performance) in this part.

Therefore, the protruding portions 2211bDt1 and 2211bDt3 are formed at respective locations where they overlap the gravity center transverse plane (gravity center transverse line 532) on the optical axis projection plane.

In a case where the main engagement portion 2211bD is slidably engaged with the main guide shaft 230ab only via the protruding portions 2211bDt1 and 2211bDt3, there is, for example, a possibility that the engagement can be released when an external force is applied in a direction perpendicular to the gravity center transverse plane. To prevent this, the protruding portions 2211bDt2 and 2211bDt4 are formed at respective locations where they overlap a plane, which is orthogonal to the gravity center transverse plane and at the same time includes the central axis of the main guide shaft 230ab, on the optical axis projection plane. This improves the durability against the stress generated when driving the lens assembly 220D and the external force.

Then, in the main engagement portion 2211bD, since the spacings from the outer peripheral surface of the main guide shaft 230ab are increased in the intermittent portions 2211bDv1 to 2211bDv4, the viscous forces come to be hardly generated, and as a result, it is possible to reduce the guide resistance.

Note that although in the lens holder 221D, the main engagement portion (not shown) and the main engagement portion 2211bD are formed with four protruding portions (not shown) and the four protruding portions 2211bDt1 to 2211bDt4 and four intermittent portions (not shown) and the four intermittent portions 2211bDv1-2211bDv4, respectively, the number of the protruding portions and the intermittent portions is not limited to the above. For example, a protruding potion is formed at the point of action of the normal force 513b, protruding portions including the protruding potion and intermittent portions can be formed at respective six or eight locations such that a shape connecting respective centers of the plurality of protruding portions in the circumferential direction on the optical axis projection plane forms a regular hexagon or regular octagon.

Further, as the configuration for reducing the guide resistance, the description has been given of the configuration in which the main engagement portions are formed such that has the protruding end surfaces of the protruding portions are brought into contact with the outer peripheral surface of the main guide shaft. This is not limitative, but the inner peripheral surfaces of the main engagement portions can each be formed into a hexagon or octagon circumscribed to the outer periphery of the main guide shaft at a cross section perpendicular to the linear driving direction. In this case, the main guide shaft is brought into contact with flat surfaces on the inner peripheral surfaces of the main engagement portions at the points of action of the normal force 513b. With this, it is possible to reduce the area of the main guide sliding surfaces and thereby reduce the guide resistance while securing the component strength.

For example, although in the above-described embodiments, the description has been given of the configuration using the multi-magnetic pole type linear actuator for the linear drive device, the effect related to the arrangement of the linear actuator can also be obtained by using a single magnetic pole type linear actuator. Further, the linear drive device according to the present embodiments can be applied not only to the lens assembly as the driven body, but can be applied to a variety of devices required to linearly move a driven body.

According to the present disclosure, it is possible to provide the linear drive device that is low in guide resistance and prevents the product from being increased in size and weight.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-080413, filed May 13, 2025, which is hereby incorporated by reference herein in its entirety.

What is claimed is:

1. A linear drive device including:
a driven body;
a linear guide that supports the driven body in a state movable in a first direction; and
a linear actuator that drives the driven body in the first direction,
wherein the linear guide has a hollow cylindrical shaft having an internal space extending in the first direction,
wherein the linear actuator has a field part having a permanent magnet and a yoke, and a coil part having coils,
wherein the field part is arranged in the internal space of the shaft,
wherein the coil part is arranged coaxially with the shaft with a fixed spacing between inner peripheral surfaces of the coils and an outer peripheral surface of the shaft,
wherein the driven body has two main engagement portions which are arranged with a certain spacing in the first direction and are slidably engaged with the shaft, and
wherein sliding surfaces of the main engagement portions, which are slidably engaged with the shaft, have a comb-tooth shape which is intermittently brought into contact with the outer peripheral surface of the shaft in a circumferential direction.

2. The linear drive device according to claim 1, wherein the coil part is fixed to the driven body and at the same time is arranged between the two main engagement portions.

3. The linear drive device according to claim 2, wherein the shaft is a hollow cylindrical bar,
wherein the coil part has a substantially hollow cylindrical shape, and
wherein the coil part and the shaft are arranged substantially coaxially with each other.

4. The linear drive device according to claim 3, wherein the shaft is in contact with the main engagement portions at points where a line connecting a center of the shaft and the center of gravity of the driven body intersects, on a projected plane as viewed from the first direction, with the main engagement portions.

5. The linear drive device according to claim 3, wherein the permanent magnet and the yoke have respective solid cylindrical shapes.

6. The linear drive device according to claim 5, wherein in the field part, a plurality of the permanent magnets and at least one of the yokes are alternately arranged in the first direction.

7. The linear drive device according to claim 6, wherein a filling member for positioning the field part in the first direction is disposed in an area from at least one end of the shaft to the field part in the internal space of the shaft, and
wherein the filling member is smaller in density than the permanent magnets and the yokes.

8. The linear drive device according to claim 7, wherein a cushioning member for biasing the field part in the first direction in the internal space of the shaft is disposed in the internal space of the shaft, and
wherein the cushioning member has elasticity.

9. A lens barrel including a linear drive device as recited in claim 1, and
wherein the driven body is a lens assembly in which a focus lens or a zoom lens is fixed to a lens holder.

10. An image capturing system including:
a lens barrel as recited in claim 9, and
an image sensor to which the lens barrel can be removably attached, and which converts an optical image formed through the lens barrel to electrical signals.

11. An image capturing apparatus including:
a lens barrel as recited in claim 9, and
an image capturing apparatus body including an image sensor that converts an optical image formed through the lens barrel to electrical signals.
